(19) United States
(12) Patent Application Publication
(10) Pub. No.: US 2007/0005918 A1
(43) Pub. Date: Jan. 4, 2007

(54) Methods and apparatus to provide interface access control

(76) Inventors: Michael A. Rothman, Puyallup, WA (US); Vincent J. Zimmer, Federal Way, WA (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/170,278

(22) Filed: Jun. 29, 2005

(51) Int. Cl. G06F 12/14

(52) U.S. Cl. 711/163

(57) ABSTRACT

Methods and apparatus to provide interface access control are disclosed. One example method may include preventing access to a portion of a medium. Such a method may include determining a location of the portion of the medium to which access is to be prevented, producing an indication when the medium is being accessed, in response to the indication, determining if the access to the medium includes access of the portion of the medium to which access is to be prevented and blocking access to the medium if the access to the medium includes access to the portion of the medium to which access is to be prevented. Other embodiments are described and claimed.

### TECHNICAL FIELD

The present disclosure pertains to information processing devices and methods and, more particularly, to methods and apparatus to provide interface access control.

### BACKGROUND

A general purpose computing system typically includes a processor, memory, and a hard disk drive. The processor is configured to read instructions from the hard disk drive and write those instructions into memory, at which point the processor can then execute the instructions. Conventionally, the processor interfaces with the hard disk drive through a hard disk drive adapter or controller, such as an integrated drive electronics (IDE) controller implemented using an AT attachment (ATA) interface and command format.

In a general purpose computing system, it is desirable to reserve or protect a portion of the hard disk drive space use by other entities. For example, it may be desirable to reserve a section of hard disk drive memory to hold instructions that are executed by firmware in a processor pre-boot phase of operation. The use of a hardware-protected storage area in this manner is advantageous for purposes of storing private platform data that otherwise would not fit in the platform's private non-volatile storage, which is typically implemented in flash memory. To preserve the integrity of the firmware instructions, it is necessary to prevent subsequent entities, such as an operating system (OS), from overwriting the firmware instructions that are stored in the reserved or protected space.

One conventional approach to reserving a portion of the hard disk drive is to leverage technology built into a hard disk drive adapter. For example, a hard disk drive adapter is conventionally instructed not to overwrite portions of the hard disk drive by specifying addresses to which the hard disk drive adapter is not to write information. This technique of using the hard disk drive adapter to allocate private-use areas of the hard disk drive is commonly referred to as host protected addressing (HPA). However, the HPA scheme is not supported by all hard disk drive adapters.

### BRIEF DESCRIPTION OF THE DRAWINGS

FIG. 1 is a diagram of an example processor system including interface access control functionality.

FIG. 2 is a block diagram showing further detail of an example implementation of the media protector of FIG. 1.

FIG. 3 is a flow diagram of an example media protection process that may be carried out by the system of FIG. 1.

FIG. 4 is a block diagram representation of the mass storage device of FIG. 1 when the interface access control functionality is active.

### DETAILED DESCRIPTION

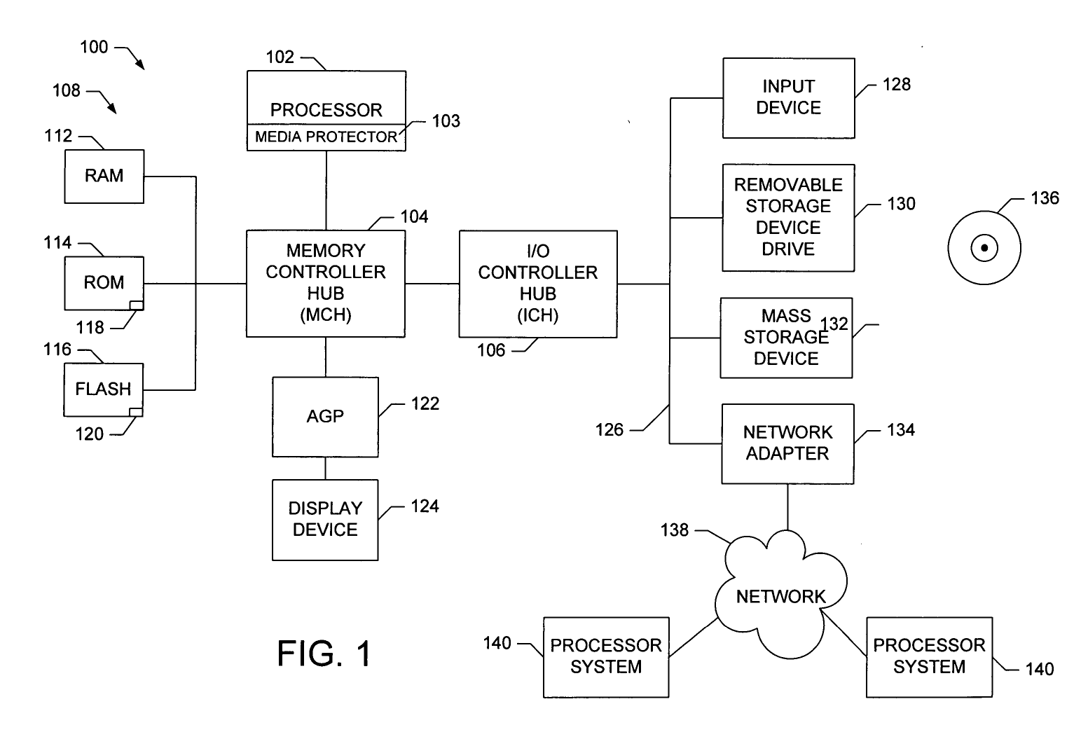

FIG. 1 is a diagram of the example processor system 100. The example processor system 100 includes a processor 102 including a media protector 103 and having an associated memory controller hub (MCH) 104 and an input/output controller hub (ICH) 106. The MCH 104 communicatively couples the processor 102 to, among other components, associated system memory 108 and a display subsystem 110. In this manner, the processor 102 may be configured to communicate with and control the associated system memory 108 and the display subsystem 110. Additionally, as described below, the MCH 104 is configured to allow the processor 102 to communicate with the ICH 106 to facilitate communication with further I/O devices.

The example processor system 100 may be, for example, a conventional desktop personal computer, a notebook computer, a workstation, or any other computing device. The processor 102 may be any type of processing unit, such as a microprocessor from the Intel® Pentium® family of microprocessors, the Intel® Itanium® family of microprocessors, and/or the Intel XScale® family of processors. In a multi-processor system, multiple processors that are substantially similar or identical to the processor 102 may be communicatively coupled to one another.

As described below, the media protector 103 may be implemented using software that interacts with the MCH 104 and the ICH 106 to reserve or protect a portion of the mass storage device 132. For example, this reservation may be made to facilitate the storage of instructions to be executed by the processor 102 when the processor 102 is in a pre-boot phase of operation. The reservation may be implemented using trapping and system management interrupt (SMI) functionality provided by the ICH 106. Alternatively or additionally, the reservation may be carried out using power management interrupt (PMI) functionality.

The associated system memory 108 includes a RAM 112, a ROM 114, and a flash memory 116. The ROM 114 and the flash memory 116 of the illustrated example may respectively include boot blocks 118 and 120. The boot blocks 118 and 120 may be used to store pre-boot firmware and other firmware resources.

The display subsystem 110 includes a display adapter 122 and the display device 124. The display adapter 122 may be, for example, an advanced graphics port (AGP) display adapter conformant to the AGP V3.0 Interface Specification, published September 2002 by Intel Corporation, Santa Clara, Calif. or any other display adapter capable of rendering viewable information (i.e., graphics, text, pictures, etc.). The display adapter 122 may be used to render viewable information on the display device 124. The display device 124 may be, for example, a liquid crystal display (LCD) monitor, a cathode ray tube (CRT) monitor, or any other suitable device that acts as an interface between the processor 102 and a user via the display adapter 122.

The ICH 106 links the processor 102 to various I/O devices through the MCH 104. In one example, the ICH 106 may be implemented using the I/O Controller Hub 6 (ICH6) chipset from Intel, Corporation. The ICH 106 includes a standard I/O device bus 126 which may be, for example, a USB port, an RS-232 serial port, an IEEE-1394 (i.e., Firewire) port, or any other I/O interface bus capable of communicatively coupling a peripheral device to the processor system 100. As shown in FIG. 1, the standard I/O device bus 126 may be communicatively coupled to an input device 128, a removable storage device drive 130, a mass storage device 132, and a network adapter 134. Further detail regarding the ICH 106 may be found in the Intel I/O Controller Hub 6 (ICH 6) Family Datasheet for the Intel 82801FB ICH6, 82801FR ICH6R and 82801FBM ICH6-M I/O Controller Hubs, Dated January 2005, which is incorporated herein by reference.

In one example, the ICH 106 supports trapping and SMI generation in both serial ATA (SATA) and IDE configurations. Tables 1 and 2 below show the data configuration of the trapping control registers for DATA and IDE configurations, respectively. In Tables 1 and 2 below SMI# refers to the interrupt pin that is toggled to generate an SMI.

TABLE 1

| Bit | Description |
|---|---|
| 7:4 | Reserved |
| 3 | Secondary Slave Trap (SST)-R/W. Enables trapping and SMI# |
| | assertion on legacy I/O accesses to 170h-177h and 376h. The active |
| | device on the secondary interface must be device 1 for the trap |
| | and/or SMI# to occur. |
| 2 | Secondary Master Trap (SPT)-R/W. Enables trapping and SMI# |
| | assertion on legacy I/O accesses to 170h-177h and 376h. The active |
| | device on the secondary interface must be device 0 for the trap |
| | and/or SMI# to occur. |
| 1 | Primary Slave Trap (PST)-R/W. Enables trapping and SMI# |
| | assertion on legacy I/O accesses to 1F0h-1F7h and 3F6h. The active |
| | device on the secondary interface must be device 1 for the trap |
| | and/or SMI# to occur. |
| 0 | Primary Master Trap (PMT)-R/W. Enables trapping and SMI# |
| | assertion on legacy I/O accesses to 1F0h-1F7h and 3F6h. The active |
| | device on the secondary interface must be device 0 for the trap |
| | and/or SMI# to occur. |

TABLE 2

| Bit | Description |
|---|---|
| 7:2 | Reserved |
| 1 | Slave Trap (PST) - R/W. Enables trapping and SMI# assertion on |
| | legacy I/O accesses to 1F0h-1F7h and 3F6h. The active device must |
| | be the slave device for the trap and/or SMI# to occur. |
| 0 | Master Trap (PMT) - R/W. Enables trapping and SMI# assertion on |
| | legacy I/O accesses to 1F0h-1F7h and 3F6h. The active device must |
| | be the master device for the trap and/or SMI# to occur. |

The input device 128 may be implemented by a keyboard, a mouse, a touch screen, a track pad or any other device that enables a user to provide information to the processor 102.

The removable storage device drive 130 may be, for example, an optical drive, such as a compact disk-recordable (CD-R) drive, a compact disk-rewritable (CD-RW) drive, a digital versatile disk (DVD) drive, or any other optical drive. It may alternatively be, for example, a magnetic media drive. The removable storage device drive 130 has associated removable storage media 136 that is complimentary to the removable storage device drive 130, inasmuch as the media 136 is selected to operate with the drive 130. For example, if the removable storage device drive 130 is an optical drive, the removable storage media 136 may be a CD-R disk, a CD-RW disk, a DVD disk, or any other suitable optical disk. On the other hand, if the removable storage device drive 130 is a magnetic media device, the removable storage media 136 may be, for example, a diskette, or any other suitable magnetic storage media.

The mass storage device 132 may be implemented using a conventional hard disk drive or any other suitable media. Additionally, the mass storage device 132 may include a disk controller or other associated hardware that facilitates the interaction between the processor 102 and the mass storage device 132. The mass storage device 132 may used to store, for example, operating systems and applications. Additionally, as described below, a portion of the mass storage device may be reserved for use by the processor 102 during a pre-boot phase of operation. To that end, the processor 102, in particular the media protector 103, interacts with the ICH 106 to cause the ICH 106 to trap input/output to/from the mass storage device 132. The input/output may be examined to determine if it pertains to the reserved portion. Accordingly, the mass storage device 132 may be used to store firmware resources.

The network adapter 134 may be, for example, an Ethernet card or any other card that may be wired or wireless. The network adapter 134 provides network connectivity between the processor 102 and a network 138, which may be a local area network (LAN), a wide area network (WAN), the Internet, or any other suitable network. As shown in FIG. 1, further processor systems 140 may be coupled to the network 138, thereby providing for information exchange between the processor 102 and the processor systems 140.

As described below in detail, in relevant operation, the media protector 103 determines the addresses of the mass storage device 132 that are to be protected or reserved. The media protector 103 then instructs the ICH 106 to trap on reads and/or writes to the mass storage device 132. Subsequently, when the ICH 106 determines that the mass storage device 132 is being accessed, the ICH 106 traps the relevant request and alerts the media protector 103 of the same. As described in detail below, the media protector 103 handles the request in a manner that protects the designated areas of the mass storage device 132. This operation is advantageous in that it may be carried out independent of the type of hard disk controller that is being used. That is, the hard disk drive controller in the system need not support HPA.

The establishment of a protected area in the manner described herein is advantageous because it provides the ability to off-load payload that would normally be provided in flash memory (or firmware) to a large media such as a hard disk drive. This area also provides the ability to save critical file system structures for recovery of broken boot structures that may have been affected by a virus or malfunctioning software. Such an area is operating system independent and, therefore, critical system core dumps may be made in pre-boot without needing native file system support for the media.

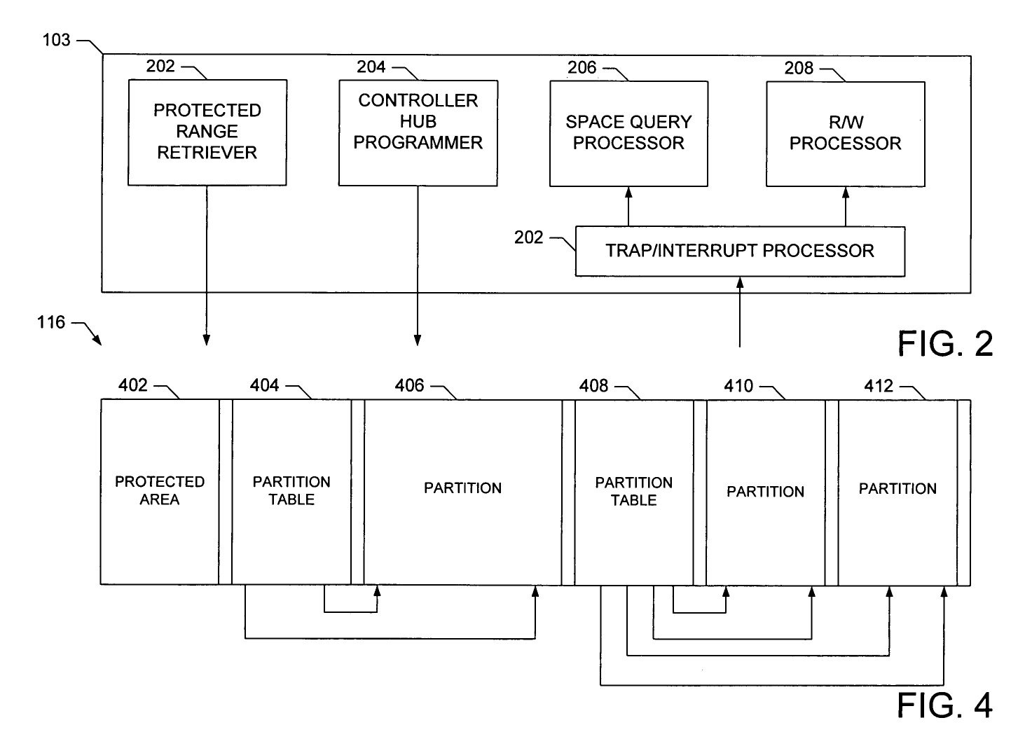

As shown in further detail in FIG. 2, according to one example, the media protector 103 includes a protected range retriever 202 and a controller hub programmer 204. The media protector 103 also includes a space query processor 206 and a read/write (R/W) processor 208, each of which is coupled to a trap/interrupt processor 210. The components shown in FIG. 2 may be implemented using firmware, software, hardware, or any suitable combination thereof.

In operation, the protected range retriever 202 reads a variable specifying an address or range of addresses on the mass storage device 132 that are to be protected. For example, the address or range of addresses may be specified in a logical block address (LBA) format. In one example implementation, the address or range of addresses that are to be protected may be stored in a non-volatile memory, such as the ROM 114 or the flash memory 116 and read by the processor protected range retriever 202 during a pre-boot phase of processor 102 operation.

The controller hub programmer 204 then programs the ICH 106 via the MCH 104 to trap and/or place interrupts on addresses associated with accesses to the mass storage device 132. For example, an SMI may be placed on IDE/SATA accesses so that when the mass storage device 132 is accessed, the ICH 106 alerts the system that such an access has occurred. Subsequently, based on the particulars of the access (e.g., the address being accessed, the nature of the access (read or write)), the access may be allowed or disallowed.

When an SMI or a trap is received from the ICH 106, the trap/interrupt processor 210 determines whether the access to the requested area is a space query having the purpose of determining the amount of free space available or a read or write to a the protected address(s). If the access is a space query, the trap/interrupt processor 210 passes the space query to the space query processor 206. The space query processor 206 determines the response to be made to the access based on whether address redirection is enabled (i.e., whether there is a protected area). Alternatively, if the trap/interrupt is a read or write, the R/W processor 208 determines if the read or write falls within the protected area (e.g., in a protected LBA) and restricts or permits the read or write accordingly.

Although the following discloses example systems including, among other components, software and/or firmware executed on hardware, it should be noted that such systems are merely illustrative and should not be considered as limiting. For example, it is contemplated that any or all of these hardware and software components could be embodied exclusively in dedicated hardware, exclusively in software, exclusively in firmware, or in some combination of hardware, firmware and/or software. Accordingly, while the following describes example systems, persons of ordinary skill in the art will readily appreciate that the examples are not the only way to implement such systems.

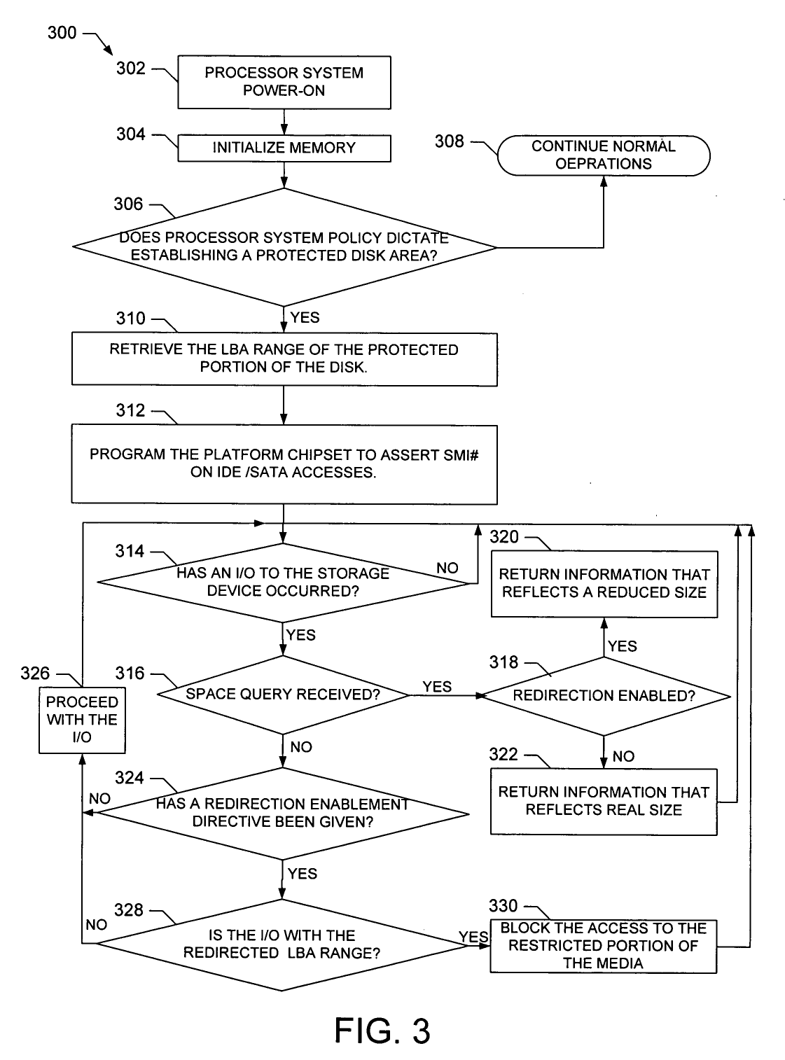

FIG. 3 is a flow diagram illustrating an example media protection process 300, such as may be carried out by one or more components of processor system of FIG. 1. For example, certain blocks of the process 300 may be carried out by the media protector 103, which is implemented using the processor 102. Additionally, some or all parts of the process 300 may be carried out in a pre-boot environment (i.e., an environment in which an operating system is not operating) or in a runtime environment that is running an operating system. Further, some parts of the process 300 may be carried out manually or may be implemented using hardware, software, firmware, or any suitable combination thereof.

The process 300 powers the processor system (e.g., the processor system 100 of FIG. 1) (block 302), at which point the processor (e.g., the processor 102) begins operating in a pre-boot environment. Subsequently, memory (e.g., one or more the memories of FIG. 1) is initialized (block 304). At this point, the processor may read from the section of disk that will later be protected. This is because the protection has not yet been put in place by the processor, which, as described below, initializes the chipset to generate an SMI for each access to the media having a protected area.

The process 300 then determines if the processor system policy dictates establishing a protected disk area (block 306). This determination may be carried out by executing one or more firmware instructions in the pre-boot environment or by reading one or more variables stored in firmware. For example, during the pre-boot phase of processor operation, the processor may read a register or memory location and the contents of that location determine whether a protected disk area should be established. If no protected disk area is to be established, the process 300 continues normal operations (block 308), during which the processor continues with its pre-boot operations and loads an operating system.

Alternatively, if a protected disk area is to be established (block 306), the process 300 retrieves the LBA range of the protected portion (block 310). As will be readily appreciated, the LBA range may be stored in any suitable non-volatile memory location that is accessible by the processor. For example, the LBA range may be stored in flash memory, ROM, or any other suitable location. It may be possible that there is a protected disk area specified, but no address is supplied because redirection is not enabled.

As the processor (e.g., the processor 102) continues to initialize the processor system (e.g., the processor system 100), the processor programs the platform chipset (e.g., the ICH 106) to assert a SMI on IDE/SATA accesses (block 312). Programming the chipset in this manner enables the chipset (e.g., the ICH 106) to inform the processor (e.g., the processor 102), when accesses are made to the hard disk drive (e.g., the mass storage device 132 of FIG. 1). As described below, once the processor is aware that the hard disk drive is being accessed, the processor may determine if the access involves the protected disk area.

At this point, an interrupt (SMI or PMI) is set to detect hard disk drive accesses and, therefore, the processor may continue its boot process and eventually load an operating system. Accordingly, the process 300 monitors for access (i.e., an I/O) to the disk (block 314). When a disk access occurs, an SMI is generated by the chipset (e.g., the ICH 106) and the processor (e.g., the processor 102) receives the interrupt.

When a disk access has occurred (block 314), the process 300 determines if the disk access is a space query, which is a request for a report of the available space on the disk (block 316). If a space query is received, the process 300 determines if redirection is enabled (block 318). It may be determined if redirection is enabled by detecting if an address or logical block of addresses has been specified in memory. If redirection is enabled, the process 300 returns an indication of disk space that reflects a reduced size due to the protected disk area (block 320). Alternatively, if redirection is not enabled (block 318), the process 300 returns a disk size reflective of the real size of the disk (block 322).

Alternatively, if I/O was not a space query (block 316), the process 300 determines if a redirection enablement directive has been given (block 324). If the redirection directive has not been give, the process proceeds with the I/O because there is no protected area defined (block 326).

If the redirection enablement directive has been given (block 324), the process determines if the address associated with the I/O falls within the protected LBA identified in block 310 (block 328). If the address associated with the I/O does not fall within the protected LBA, the I/O is processed in the usual manner because the I/O does not involve the protected disk space. Alternatively, if the address associated with the I/O falls within the LBA (block 328), the I/O is blocked because the I/O was an attempt to read from or write to the restricted portion of the disk (block 330).

FIG. 4 shows one example of media, such as the mass storage device 132, which is partitioned and includes a protected LBA 402. In particular, the mass storage device 132 includes a first partition table 404 that defines the starting and ending addresses of a first partition 406. A second partition table 408 defines the starting and ending addresses of second and third partitions 410, 412. As described above, the protected LBA 402 may be used to store information that is used in the pre-boot phase of processor operation. To prevent the inadvertent overwriting or corruption of the information stored in the protected LBA 402, the ICH may be programmed to generate interrupts when the processor accesses the mass storage device 132. In this manner, the processor may examine the accesses to the mass storage device 132 to determine if those accesses involve the protected LBA 402, thereby preventing information in the LBA 402 from being tampering.

The first and second partition tables 404, 408 may be part of an HPA area and data may be stored in the partitions 406, 410, 412. As will be readily appreciated by those having ordinary skill in the art, the mass storage device 132 may include more or fewer partitions than those shown in FIG. 4.

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of preventing access to a portion of a storage medium, the method comprising:
determining a location of the portion of the storage medium to which access is to be prevented;
producing an indication when the storage medium is being accessed;
in response to the indication, determining if the access to the storage medium includes access of the portion of the storage medium to which access is to be prevented; and
blocking access to the storage medium if the access to the storage medium includes access to the portion of the storage medium to which access is to be prevented.

2. A method as defined by claim 1, wherein determining the location of the portion of the storage medium to which access is to be prevented includes reading the location from memory.

3. A method as defined by claim 1, wherein determining the location of the portion of the storage medium to which access is to be prevented includes reading a logical block address from memory.

4. A method as defined by claim 1, wherein determining the location of the portion of the storage medium to which access is to be prevented includes reading a range of logical block addresses from memory.

5. A method as defined by claim 1, further including determining whether a space query has been received.

6. A method as defined by claim 5, further including responding to the space query with information reflective of the storage medium size less the size of the portion of the storage medium to which access is to be prevented.

7. A method as defined by claim 1, further including programming a controller to generate an interrupt on access to the storage medium.

8. A method as defined by claim 7, wherein determining the location of the portion of the storage medium to which access is to be prevented and programming the controller to generate the interrupt on access to the storage medium are performed in a pre-boot phase of processor operation.

9. An article of manufacture comprising a machine-accessible medium having a plurality of machine accessible instructions that, when executed, cause a machine to:
determine a location of the portion of the medium to which access is to be prevented;
in response to an indication that the medium is being accessed, determine if the access to the medium includes access of the portion of the medium to which access is to be prevented; and
block access to the medium if the access to the medium includes access to the portion of the medium to which access is to be prevented.

10. A machine-accessible medium as defined by claim 9, wherein determining the location of the portion of the medium to which access is to be prevented includes reading the location from memory.

11. A machine-accessible medium as defined by claim 9, wherein determining the location of the portion of the medium to which access is to be prevented includes reading a logical block address from memory.

12. A machine-accessible medium as defined by claim 9, wherein determining the location of the portion of the medium to which access is to be prevented includes reading a range of logical block addresses from memory.

13. A machine-accessible medium as defined by claim 9, wherein the plurality of machine accessible instructions, when executed, cause a machine to determine whether a space query has been received.

14. A machine-accessible medium as defined by claim 13, wherein the plurality of machine accessible instructions, when executed, cause a machine to respond to the space query with information reflective of the medium size less the size of the portion of the medium to which access is to be prevented.

15. A machine-accessible medium as defined by claim 9, wherein the plurality of machine accessible instructions, when executed, cause a machine to program a controller to generate an interrupt on access to the medium.

16. A machine-accessible medium as defined by claim 15, wherein determining the location of the portion of the medium to which access is to be prevented and programming the controller to generate the interrupt on access to the medium are performed in a pre-boot phase of processor operation.

17. A system comprising:
a medium having a portion to which access is to be prevented;
a controller responsive to the medium; and
a processor responsive to the controller and programmed to:
determining a location of the portion of the medium to which access is to be prevented;
program the controller to produce an indication when the medium is being accessed;
in response to the indication, determining if the access to the medium includes access of the portion of the medium to which access is to be prevented; and
blocking access to the medium if the access to the medium includes access to the portion of the medium to which access is to be prevented.

18. A system as defined by claim 17, wherein determining the location of the portion of the medium to which access is to be prevented includes reading a logical block address from memory.

19. A method as defined by claim 17, further including determining whether a space query has been received.

20. A method as defined by claim 17, wherein determining the location of the portion of the medium to which access is to be prevented and programming the controller to generate the interrupt on access to the medium are performed in a pre-boot phase of processor operation.
